(19) United States
(12) Patent Application Publication
(10) Pub. No.: US 2009/0309438 A1
(43) Pub. Date: Dec. 17, 2009

(54) Motor Structure

(76) Inventors: Alex Horng, Kaohsiung (TW); Duo Nian Shan, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/174,687

(22) Filed: Jul. 17, 2008

Related U.S. Application Data
(63) Continuation-in-part of application No. 12/155,959, filed on Jun. 12, 2008.

(51) Int. Cl. H02K 5/16

(52) U.S. Cl. 310/90

(57) ABSTRACT

A motor structure includes a housing having a shaft tube receiving a bearing. The shaft tube includes a positioning section on an outer periphery thereof. A rotor includes a shaft rotatably extending through the bearing. A stator is mounted around the shaft tube and includes an upper bobbin having an abutting portion and a lower bobbin having an engaging portion. The positioning section of the shaft tube provides the engaging portion of the lower bobbin with an axial supporting force along a longitudinal axis of the shaft tube to position the stator in a fixed axial position relative to the bearing along a longitudinal axis of the shaft tube. Also, the abutting portion of the upper bobbin abuts the bearing to prevent the bearing from disengaging from the shaft tube.

### CROSS REFERENCE TO RELATED APPLICATION

This application is a continuation-in-part application of U.S. patent Ser. No. 12/155,959, filed on Jun. 12, 2008.

### BACKGROUND OP THE INVENTION

The present invention relates to a motor structure and, more particularly, to a motor structure with improved positioning device for positioning a stator and a bearing of the motor structure.

FIG. 1 shows a conventional motor structure including a housing 70, a rotor 80, and a stator 90. Housing 70 includes a hollow shaft tube 71 receiving a bearing 72, a retaining plate 73, a supporting plate 74, and an oil end cap 75. Rotor 80 includes a shaft 81 rotatably extending through bearing 72. Stator 90 is mounted around shaft tube 71 and includes upper and lower bobbins 91 and 92, a plurality of silicon steel plates 93 sandwiched between upper and lower bobbins 91 and 92, and a winding 94 wound around silicon steel plates 93. Upper bobbin 91 includes an abutting portion 911 in the form of a plurality of annularly spaced plates or an annular ring to abut bearing 72, preventing disengagement of bearing 72 from shaft tube 71. Bearing 72 and shaft tube 71 are in loose coupling with each other and have a small gap therebetween to allow easy assembly and to prevent shaft tube 71 from being squeezed and thus deformed by bearing 72. However, shaft tube 71 cannot provide a reliable positioning effect for stator 90. In a case that stator 90 is in a higher assembling position relative to bearing 72 (FIG. 1), abutting portion 911 of upper bobbin 91 does not abut bearing 72 though there is no risk of disengagement of bearing 72 out of shaft tube 71. As a result, bearing 72 can not be reliably positioned in shaft tube 71 such that noise occurs easily by resonance of bearing 72 and other components during operation of the motor. In another case that stator 90 is in a lower assembling position relative to bearing 72 (FIG. 2), abutting portion 911 of upper bobbin 91 presses against bearing 72 by resiliency of abutting portion 911 to prevent bearing 72 from disengaging from shaft tube 71. However, abutting portion 911 is liable to deform to an extent exceeding its tolerable limit, leading to breakage of abutting portion 911.

A need exists for a motor structure with a positioning device to reliably position the stator relative to the bearing.

### BRIEF SUMMARY OF THE INVENTION

The present invention solves this need and other problems in the field of motor stator positioning devices by providing, in a preferred form, a motor structure includes a housing having a shaft tube receiving a bearing. The shaft tube includes a positioning section on an outer periphery thereof. A rotor includes a shaft rotatably extending through the bearing. A stator is mounted around the shaft tube and includes an upper bobbin, a lower bobbin, a plurality of silicon steel plates sandwiched between the upper and lower bobbins, and a winding wound around the plurality of silicon steel plates. The upper bobbin includes an abutting portion, and the lower bobbin includes an engaging portion. The positioning section of the shaft tube provides the engaging portion of the lower bobbin with an axial supporting force along a longitudinal axis of the shaft tube to position the stator in a fixed axial position relative to the bearing along the longitudinal axis of the shaft tube. And the abutting portion of the upper bobbin abuts the bearing to prevent the bearing from disengaging from the shaft tube.

In an example, the shaft tube includes an upper section and a lower section having an outer diameter larger than that of the upper section. An annular shoulder is formed between the upper and lower sections and forms the positioning section. The engaging portion of the lower bobbin includes an annular flange on an inner periphery thereof. The annular flange rests on and is positioned by the annular shoulder to position the stator in the fixed axial position relative to the bearing.

In another example, the positioning section of shaft tube includes a plurality of annularly spaced blocks on the outer periphery thereof, and the engaging portion of the lower bobbin includes an annular flange on an inner periphery thereof. The annular flange rests on and is positioned by the blocks to position the stator in the fixed axial position relative to the bearing.

In a further example, the positioning section of shaft tube includes a plurality of annularly spaced protrusions on the outer periphery thereof, and the engaging portion of the lower bobbin includes an annular groove on an inner periphery thereof. The protrusions are engaged in the annular groove to position the stator in the fixed axial position relative to the bearing.

In still another example, the positioning section of the shaft tube includes a plurality of annularly spaced ribs extending in a direction parallel to the longitudinal axis of the shaft tube. Each rib has a top face spaced from a top edge of the shaft tube. The engaging portion of the lower bobbin includes an annular flange on an inner periphery thereof. The annular flange rests on and is positioned by the top faces of the ribs to position the stator in the fixed axial position relative to the bearing. The outer periphery of the shaft tube further includes a limiting rib extending between and spaced from two of the ribs adjacent to each other. The limiting rib has an upper end extending to the top edge of the shaft tube. The annular flange of the lower bobbin includes a through-hole through which the limiting rib extends, preventing rotation of the stator. The stator includes a limiting groove in an inner periphery thereof and aligned with the through-hole for receiving and positioning the limiting rib.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a cross sectional view of a conventional motor structure with a stator in a higher assembling position relative to a bearing.

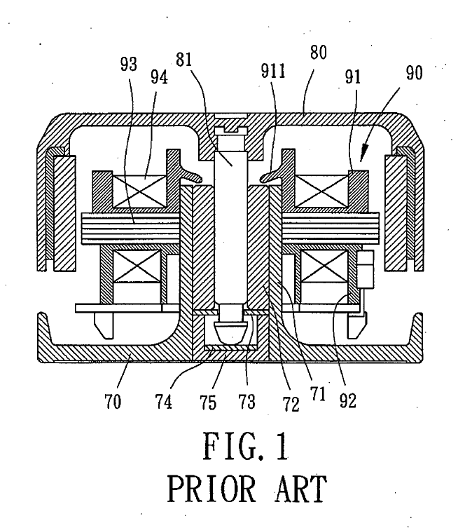

FIG. 2 shows a cross sectional view of the conventional motor structure of FIG. 1 with the stator in a lower assembling position relative to the bearing.

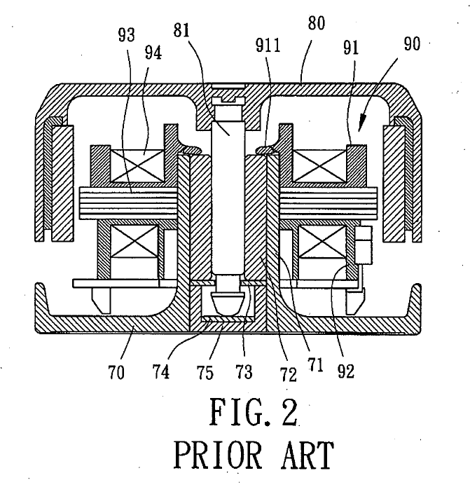

FIG. 3 shows a cross sectional view of a motor structure of a first embodiment according to the preferred teachings of the present invention.

FIG. 4 shows a partial, perspective view of a shaft tube of the motor structure of FIG. 3.

FIG. 5 shows a cross sectional view of a motor structure of a second embodiment according to the preferred teachings of the present invention.

FIG. 6 shows a partial, perspective view of the shaft tube of the motor structure of FIG. 5.

FIG. 7 shows a cross sectional view of a motor structure of a third embodiment according to the preferred teachings of the present invention.

FIG. 8 shows a partial, perspective view of a shaft tube of the motor structure of FIG. 7.

FIG. 9 shows a cross sectional view of a motor structure of a fourth embodiment according to the preferred teachings of the present invention.

FIG. 10 shows a partial, perspective view of a shaft tube of the motor structure of FIG. 9.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “lower”, “upper”, “end”, “portion”, “section”, “longitudinal”, “axial”, “annular”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

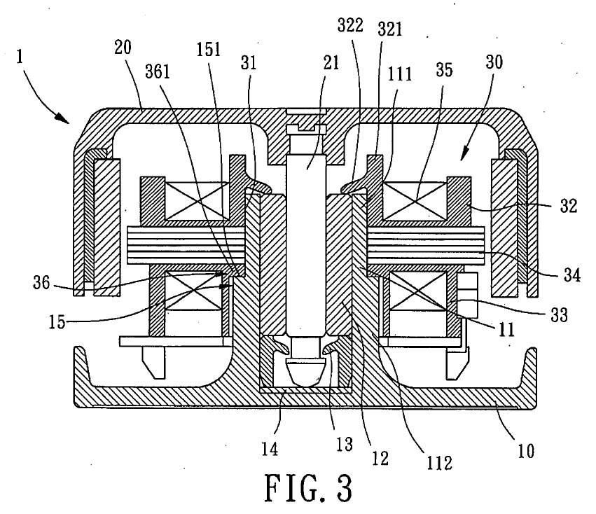

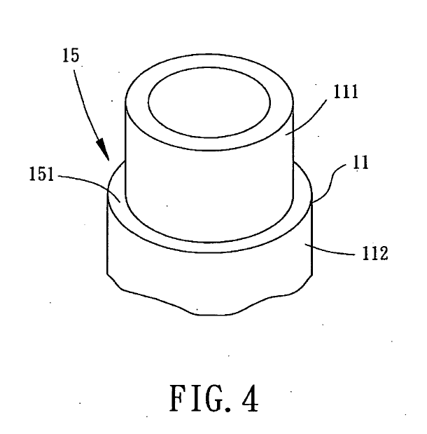

A motor structure of a first embodiment according to the preferred teachings of the present invention is shown in FIGS. 3 and 4 of the drawings and generally designated 1. According to the preferred form shown, motor structure 1 includes a housing 10, a rotor 20, and a stator 30. Housing 10 includes a hollow shaft tube 11 having a sealed bottom. Shaft tube 11 receives a bearing 12, a retaining plate 13, and a supporting plate 14. Shaft tube 11 includes a positioning section 15 on an outer periphery thereof. According to the most preferred form shown, shaft tube 11 includes an upper section 111 and a lower section 112 having an outer diameter larger than that of upper section 111, forming an annular shoulder 151 between the upper and lower sections 111 and 112. Annular shoulder 151 forms positioning section 15.

Rotor 20 includes a shaft 21 in a central portion thereof. Shaft 21 is rotatably extended through bearing 22. Thus, rotor 20 can rotate on top of housing 10.

Stator 30 includes an assembling hole 31 so as to allow stator 30 to be mounted around shaft tube 11. Preferably, stator 30 is coupled to the outer periphery of shaft tube 11 by tight coupling, bonding, or other suitable ways to reliably fix stator 30 on shaft tube 11. Stator 30 includes upper and lower bobbins 32 and 33, a plurality of silicon steel plates 34 sandwiched between upper and lower bobbins 32 and 33, and a winding 35 wound around silicon steel plates 34. Upper bobbin 32 includes an annular wall 321 extending upward from an upper end thereof to provide a shielding wall preventing dust from entering an interior of shaft tube 11 after stator 30 is coupled with shaft tube 11. An abutting portion 322 is formed on an inner periphery of annular wall 321. Abutting portion 322 can be in the form of a plurality of annularly spaced plates or an annular ring to abut bearing 12, preventing disengagement of bearing 12 from shaft tube 11. Lower bobbin 33 includes an engaging portion 36 in the most preferred form shown as an annular flange 361 on an inner periphery of lower bobbin 33. Annular flange 361 rests on and is positioned by annular shoulder 151. Namely, annular shoulder 151 of shaft tube 11 provides annular flange 361 of lower bobbin 33 with an axial supporting force along a longitudinal axis of shaft tube 11. Thus, stator 30 is positioned in a fixed axial position relative to bearing 12 along the longitudinal axis of shaft tube 11 so that stator 30 is in an appropriate assembling position neither too high nor too low relative to bearing 12. It assures abutting portion 322 of upper bobbin 32 to abut bearing 12, so as to prevent bearing 12 from disengaging from shaft tube 11.

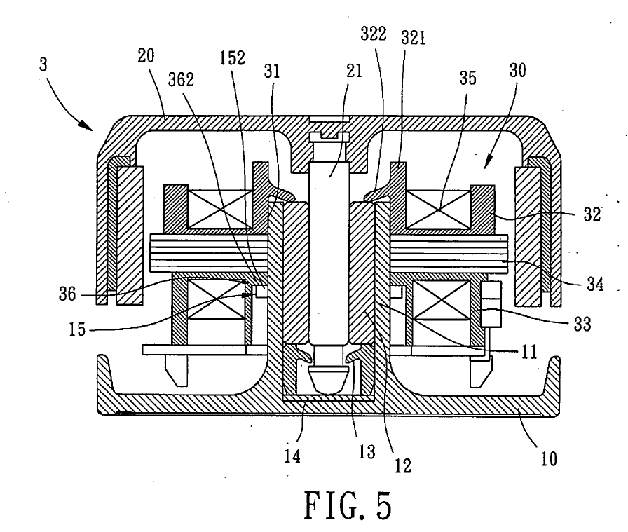

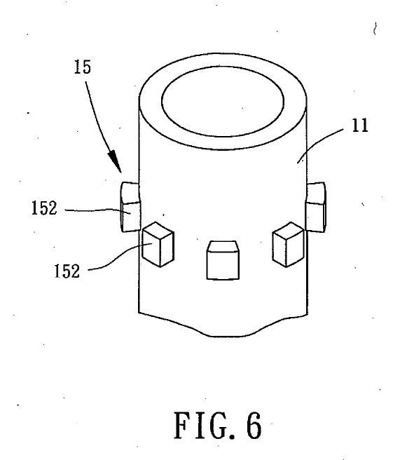

FIGS. 5 and 6 show a motor structure 3 of a second embodiment according to the preferred teachings of the present invention modified from motor structure 1, wherein positioning section 15 of shaft tube 11 includes a plurality of annularly spaced blocks 152 on the outer periphery thereof and spaced from a top edge of shaft tube 11, the engaging portion 36 of lower bobbin 33 includes an annular flange 362 on the inner periphery thereof. A bottom face of annular flange 362 rests on and is positioned by top faces of blocks 152. Namely, blocks 152 of shaft tube 11 provides annular flange 362 of lower bobbin 33 with an axial supporting force along the longitudinal axis of shaft tube 11. Thus, stator 30 is positioned in the fixed axial position relative to bearing 12 with abutting portion 322 abutting bearing 12 to prevent bearing 12 from disengaging from shaft tube 11.

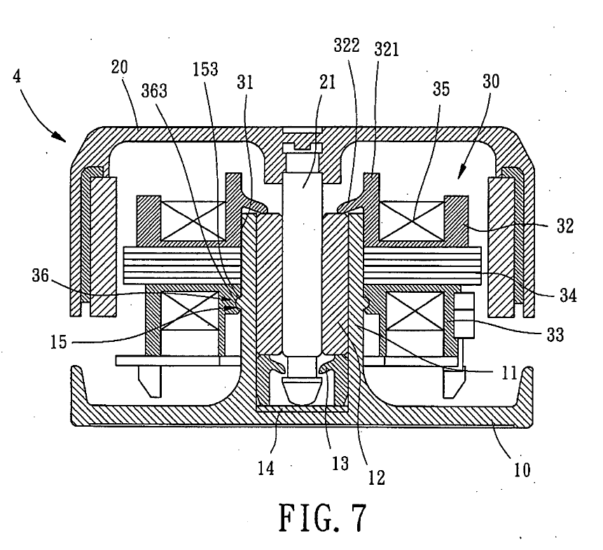

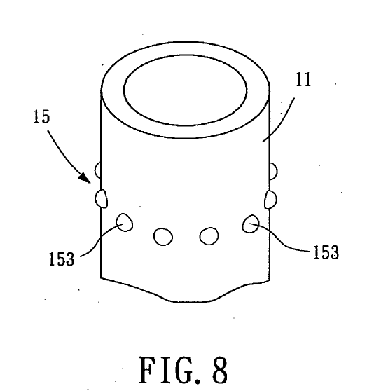

FIGS. 7 and 8 show a motor structure 4 of a third embodiment according to the preferred teachings of the present invention modified from motor structure 3, wherein positioning section 15 of shaft tube 11 includes a plurality of annularly spaced semi-spherical protrusions 153 on the outer periphery thereof, and engaging portion 36 of lower bobbin 33 includes an annular groove 363 on an inner periphery thereof. Protrusions 153 are engaged in annular groove 363 to provide tight coupling between stator 30 and shaft tube 11. Protrusions 153 of shaft tube 11 provide lower bobbin 33 with an axial supporting force along the longitudinal axis of shaft tube 11. Thus, positioning stator 30 is positioned in the fixed axial position with abutting portion 322 abutting bearing 12 to prevent bearing 12 from disengaging from shaft tube 11.

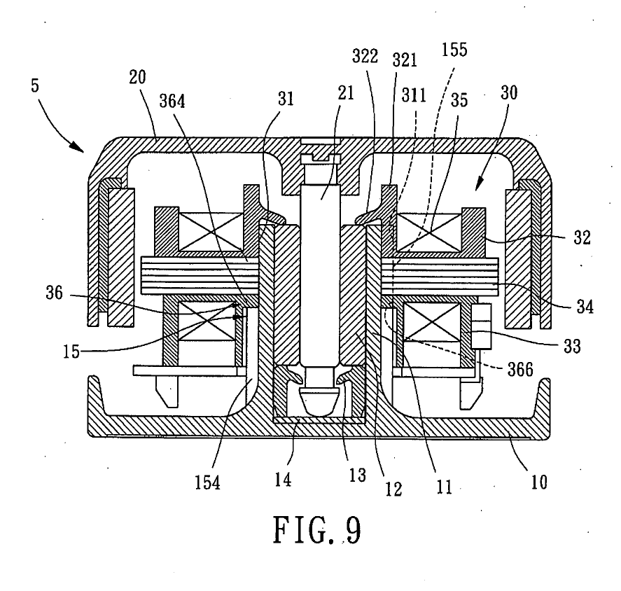

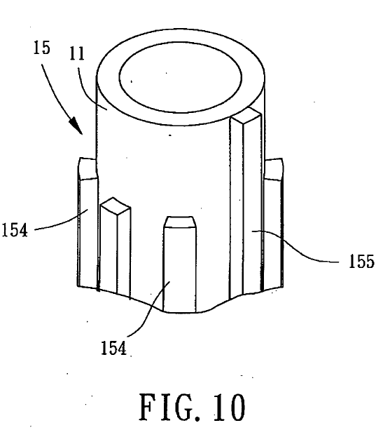

FIGS. 9 and 10 show a motor structure 5 of a fourth embodiment according to the preferred teachings of the present invention modified from motor structure 3, wherein positioning section 15 of shaft tube 11 includes a plurality of annularly spaced ribs 154 extending in a direction parallel to the longitudinal axis of shaft tube 11. Each rib 154 has a top face in an intermediate portion of the outer periphery of shaft tube 11 spaced from top edge of shaft tube 11. The outer periphery of shaft tube 11 further includes a limiting rib 155 extending between and spaced from two of ribs 154 adjacent to each other. Limiting rib 155 has an upper end extending to the top edge of shaft tube 11. Engaging portion 36 of lower bobbin 33 includes an annular flange 364 on the inner periphery thereof. Annular flange 364 includes a through-hole 366 through which limiting rib 155 extends, preventing rotation of stator 30. Furthermore, assembling hole 31 of stator 30 includes a limiting groove 311 in an inner periphery thereof and aligned with through-hole 366 for receiving and positioning limiting rib 155. A bottom face of annular flange 364 rests on and is positioned by the top faces of ribs 154.

Namely, ribs 154 of shaft tube 11 provide annular flange 364 of lower bobbin 33 with an axial supporting force along the longitudinal axis of shaft tube 11. Thus, stator 30 is positioned in the fixed axial position relative to bearing 12 with abutting portion 322 abutting bearing 12 to prevent bearing 12 from disengaging from shaft tube 11. Limiting rib 155 prevents stator 30 from rotating while mounting stator 30 around shaft tube 11, improving assembling convenience.

Due to the specific location of positioning section 15 on the outer periphery of shaft tube 11, engaging portion 36 of stator 30 is coupled with and positioned by positioning section 15 so that stator 30 is in the fixed axial position relative to bearing 12 with abutting portion 322 of upper bobbin 32 abutting bearing 12. Thus, loosening of bearing 12 due to higher assembling position of stator 30 and breakage of abutting portion 322 due to lower assembling position of stator 30 are avoided. Assembling convenience and reliable assembly are, thus, provided.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A motor structure comprising:
a housing including a shaft tube having a longitudinal axis, with a bearing being received in the shaft tube and including an upper surface, with the shaft tube including a positioning section on an outer periphery thereof;
a rotor including a shaft rotatably extending through the bearing; and
a stator including an assembling hole receiving the outer periphery of the shaft tube, with the stator including an upper bobbin, a lower bobbin, a plurality of silicon steel plates sandwiched between the upper and lower bobbins, and a winding wound around the plurality of silicon steel plates, with the upper bobbin including an annular wall and an abutting portion, with the lower bobbin including an engaging portion, with the positioning section of the shaft tube providing the engaging portion of the lower bobbin with an axial supporting force along the longitudinal axis of the shaft tube, with the annular wall of the upper bobbin including an inner periphery receiving the shaft tube and extending outwardly of the shaft tube and the upper surface of the bearing, with the abutting portion being formed on and extending downwardly and inwardly from the inner periphery of the annular wall and being in continuous engagement with the upper surface of the bearing to position the stator in a fixed axial position relative to the bearing along the longitudinal axis of the shaft tube with the abutting portion of the upper bobbin abutting the bearing to prevent the bearing from disengaging from the shaft tube.

2. The motor structure as claimed in claim 1, with the shaft tube including an upper section and a lower section having an outer diameter larger than that of the upper section, with an annular shoulder being formed between the upper and lower sections and forming the positioning section, with the engaging portion of the lower bobbin including an annular flange on an inner periphery thereof, and with the annular flange resting on and positioned by the annular shoulder to position the stator in the fixed axial position relative to the bearing.

3. The motor structure as claimed in claim 1, with the positioning section of shaft tube including a plurality of annularly spaced blocks on the outer periphery thereof, with the engaging portion of the lower bobbin including an annular flange on an inner periphery thereof, and with the annular flange resting on and positioned by the plurality of blocks to position the stator in the fixed axial position relative to the bearing.

4. The motor structure as claimed in claim 1, with the positioning section of shaft tube including a plurality of annularly spaced protrusions on the outer periphery thereof, with the engaging portion of the lower bobbin including an annular groove on an inner periphery thereof, with the lower bobbin having a lower end with the inner periphery extending therefrom, with the annular groove spaced from the lower end of the lower bobbin, and with the plurality of protrusions being engaged in the annular groove to position the stator in the fixed axial position relative to the bearing.

5. The motor structure as claimed in claim 1, with the positioning section of the shaft tube including a plurality of annularly spaced ribs extending in a direction parallel to the longitudinal axis of the shaft tube, with each of the plurality of ribs having a top face spaced from a top edge of the shaft tube, with the engaging portion of the lower bobbin including an annular flange on an inner periphery thereof, and with the annular flange resting on and positioned by the top faces of the plurality of ribs to position the stator in the fixed axial position relative to the bearing.

6. The motor structure as claimed in claim 5, with the outer periphery of the shaft tube further including a limiting rib extending between and spaced from two of the plurality of ribs adjacent to each other, with the limiting rib having an upper end extending to the top edge of the shaft tube, with the annular flange of the lower bobbin including a though-hole through which the limiting rib extends, preventing rotation of the stator, with the assembling hole of the stator including a limiting groove in an inner periphery thereof, and with the limiting rib being received and positioned in the limiting groove.

7. The motor structure as claimed in claim 1, with the outer periphery of the shaft tube further including a limiting rib extending in a direction parallel to the longitudinal axis of the shaft tube, with the limiting rib having an upper end extending to a top edge of the shaft tube, with the engaging portion of the lower bobbin including a though-hole through which the limiting rib extends, preventing rotation of the stator, with the assembling hole of the stator including a limiting groove in an inner peripheral face thereof and aligned with the through-hole, and with the limiting rib being received and positioned in the limiting groove.

8. (canceled)

9. The motor structure as claimed in claim 1, with the stator being coupled on the outer periphery of the shaft tube by tight coupling.

10. The motor structure as claimed in claim 1, with the stator being bonded to the outer periphery of the shaft tube.

11. A motor structure comprising:
a housing including a shaft tube having a longitudinal axis, with a bearing being received in the shaft tube and including an upper surface;
a rotor including a shaft rotatably extending through the bearing; and
a stator including an upper bobbin mounted round the shaft tube and a lower bobbin mounted round the shaft tube and spaced from the upper bobbin in a direction parallel to the longitudinal axis of the shaft tube, with the stator further including a plurality of silicon steel plates sandwiched between the upper and lower bobbins and a winding wound around the plurality of silicon steel plates, with the upper bobbin including an annular wall and an abutting portion, with the annular wall of the upper bobbin including an inner periphery receiving the shaft tube and extending outwardly of the shaft tube and the upper surface of the bearing, with the abutting portion being formed on and extending downwardly and inwardly from the inner periphery of the annular wall and being in continuous engagement with the upper surface of the bearing; and
means for providing the stator with an axial supporting force along the longitudinal axis of the shaft tube to position the stator in a fixed axial position relative to the bearing along the longitudinal axis of the shaft tube with the abutting portion of the upper bobbin abutting the bearing to prevent the bearing from disengaging from the shaft tube.
